(19) United States
(12) Patent Application Publication
(10) Pub. No.: US 2010/0160481 A1
(43) Pub. Date: Jun. 24, 2010

(54) Blend Composition of Polycarbonate Resin and Vinyl-Based Copolymer and Molded Product Made Using the Same

(75) Inventors: Chan-Gyun SHIN, Uiwang-si (KR); Jae-Hyung LEE, Uiwang-si (KR); Bong-Jae LEE, Uiwang-si (KR); Tae-Uk KIM, Yeosu-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/643,102

(22) Filed: Dec. 21, 2009

(30) Foreign Application Priority Data
Dec. 22, 2008 (KR) 10-2008-0131319
Dec. 24, 2008 (KR) 10-2008-0133685
Dec. 18, 2009 (KR) 10-2009-0127311
Dec. 18, 2009 (KR) 10-2009-0127312

(51) Int. Cl. C08L 69/00; C08L 51/00

(52) U.S. Cl. 523/105; 525/146; 525/67; 525/148; 524/508

(57) ABSTRACT

Disclosed is a blend composition of a polycarbonate resin and a vinyl-based copolymer that includes (A) a mixed resin including (A-1) a polycarbonate resin and (A-2) a vinyl-based copolymer and (B) an acrylic-based copolymer including at least one acrylic-based monomer, and a molded product made using the same.

### CROSS REFERENCE TO RELATED APPLICATIONS

This application claims priority to and the benefit of Korean Patent Application Nos. 10-2008-0131319, 10-2008-0133685, 10-2009-0127311, and 10-2009-0127312 filed in the Korean Intellectual Property Office on Dec. 22, 2008, Dec. 24, 2008, Dec. 18, 2009, and Dec. 18, 2009 the entire disclosure of each of which is incorporated herein by reference.

### FIELD OF THE INVENTION

The present invention relates to a blend composition of a polycarbonate resin and a vinyl-based copolymer and a molded product made using the same.

### BACKGROUND OF THE INVENTION

In general, polycarbonate resins have a comparatively high molding temperature and melt viscosity and thus may leave stress in a molded product during injection molding. In addition, polycarbonate resins have weak chemical resistance and thus may be hydrolyzed by moisture. Accordingly, a blend composition of a polycarbonate resin and a vinyl-based copolymer has been proposed to improve mechanical properties and heat resistance.

A blend of a polycarbonate resin and a vinyl-based copolymer can have excellent impact resistance, heat resistance, and mechanical strength and improved workability. It may be widely used for auto parts, computer housings, other office devices, and the like. However, the blend may exhibit dispersive phase coagulation in a fusion (melt) state under particular conditions. It may also have low mechanical strength at the weld region due to the low compatibility of a polycarbonate and a vinyl-based copolymer when a product with more than two gates is molded.

A blend composition of a polycarbonate resin and a vinyl-based copolymer can have increased weld strength by increasing the molecular weight of the polycarbonate to decrease viscosity. However, when such a blend is used for complex or thin film molding, it should be processed at a higher temperature than a conventional molding temperature due to the low viscosity. Increasing the molding temperature, however, may deteriorate weld strength, which is improved by deteriorating viscosity.

Furthermore, in order to improve low compatibility of a polycarbonate resin and a vinyl-based copolymer, a methylmethacrylate-based compatibilizer having about average compatibility of these two components may be used. However, the methylmethacrylate-based compatibilizer may have deteriorated compatibility with the polycarbonate resin at 250 to 280° C., which is a common molding temperature of the polycarbonate resin and the vinyl-based copolymer. It may also have deteriorated molding property when it is included in a large amount. Accordingly, it may not be appropriately used to improve weld strength.

### SUMMARY OF THE INVENTION

One aspect of the present invention provides a blend composition of a polycarbonate resin and a vinyl-based copolymer that can have excellent weld strength and impact resistance.

Another aspect of the present invention provides a molded product made using the blend composition of a polycarbonate resin and a vinyl-based copolymer.

According to one aspect of the present invention, a blend composition of a polycarbonate resin and a vinyl-based copolymer is provided that includes (A) a mixed resin including (A-1) about 20 to about 90 wt % of a polycarbonate resin; and (A-2) about 10 to about 80 wt % of a vinyl-based copolymer; and (B) about 0.1 to about 20 parts by weight of an acrylic-based copolymer including at least one acrylic-based monomer, based on about 100 parts by weight of the mixed resin.

The polycarbonate resin (A-1) may be prepared by reacting one or more diphenols with a compound of phosgene, halogen formate, carbonate ester, or a combination thereof.

The vinyl-based copolymer (A-2) may include a rubber modified vinyl-based graft copolymer, a linear vinyl-based copolymer, or a combination thereof.

The rubber modified vinyl-based graft copolymer may include about 5 to about 95 wt % of a vinyl-based polymer including about 50 to about 95 wt % of a first vinyl-based monomer comprising an aromatic vinyl monomer, an acrylic-based monomer, a heterocyclic monomer, or a combination thereof; and about 5 to about 50 wt % of a second vinyl-based monomer comprising an unsaturated nitrile monomer, an acrylic-based monomer, a heterocyclic monomer, or a combination thereof, which is grafted onto about 5 to about 95 wt % of a rubber polymer comprising a butadiene rubber, an acrylic rubber, an ethylene/propylene rubber, a styrene/butadiene rubber, an acrylonitrile/butadiene rubber, an isoprene rubber, an ethylene-propylene-diene (EPDM) terpolymer, a polyorganosiloxane/polyalkyl(meth)acrylate rubber composite, or a combination thereof. The linear vinyl-based copolymer may be a copolymer comprising about 50 to about 95 wt % of a first vinyl-based monomer comprising an aromatic vinyl monomer, an acrylic-based monomer, a heterocyclic monomer, or a combination thereof; and about 5 to about 50 wt % of a second vinyl-based monomer comprising an unsaturated nitrile monomer, an acrylic-based monomer, a heterocyclic monomer, or a combination thereof.

The acrylic-based copolymer (B) may be a copolymer comprising about 30 to about 90 wt % of a first monomer comprising an aromatic vinyl monomer, an acrylic-based monomer, a heterocyclic monomer, or a combination thereof; and about 10 to about 70 wt % of a second monomer comprising an aromatic vinyl monomer differing from the first aromatic vinyl monomer, an acrylic-based monomer differing from the first acrylic-based monomer, a heterocyclic monomer differing from the first heterocyclic monomer, or a combination thereof. At least one of the first monomer and the second monomer is an acrylic-based monomer. The acrylic-based copolymer (B) may be prepared by grafting the first monomer onto the second monomer to copolymerize the same. Thus the acrylic-based copolymer (B) may be a copolymer of a first acrylic-based monomer and another acrylic-based monomer differing from the first acrylic-based monomer, such as a copolymer of methylmethacrylate and ethylacrylate.

The acrylic-based copolymer (B) may have a weight average molecular weight ranging from about 100,000 to about 30,000,000 g/mol, for example, from about 1,000,000 to about 30,000,000 g/mol.

The blend composition of a polycarbonate resin and a vinyl-based copolymer may further include (C) about 1 to about 20 parts by weight of a core-shell graft copolymer including an acrylic-based shell, based on about 100 parts by weight of the mixed resin. The core-shell graft copolymer including an acrylic-based shell (C) can be prepared by grafting an unsaturated compound comprising an acrylic-based monomer, a heterocyclic monomer, an aromatic vinyl monomer, an unsaturated nitrile monomer, or a combination thereof onto a rubber polymer polymerized from a monomer comprising a diene-based monomer, an acrylic-based monomer, a silicon-based monomer, or a combination thereof. The unsaturated compound may include at least one acrylic-based monomer.

The blend composition of a polycarbonate resin and a vinyl-based copolymer may further include one or more additives, such as but not limited to an antibacterial agent, a heat stabilizer, an antioxidant, a release agent, a light stabilizer, a compatibilizer, an inorganic material additive, a surfactant, a coupling agent, a plasticizer, an admixture, a stabilizer, a lubricant, an antistatic agent, a flame proofing agent, a weather-resistance agent, a colorant, an ultraviolet (UV) blocking agent, a filler, a nucleating agent, an adhesion aid, an adhesive, or a combination thereof.

According to another aspect of the present invention, provided is a molded product made from the blend composition of a polycarbonate resin and a vinyl-based copolymer.

Hereinafter, further aspects of this disclosure will be described in detail.

### BRIEF DESCRIPTION OF THE DRAWINGS

FIG. 1 is a transmission electron microscope (TEM) photograph of a blend composition of a polycarbonate resin and a vinyl-based copolymer according to Comparative Example 1.

FIG. 2 is a transmission electron microscope (TEM) photograph of a blend composition of a polycarbonate resin and a vinyl-based copolymer according to Example 1.

FIG. 3 is a transmission electron microscope (TEM) photograph of a blend composition of a polycarbonate resin and a vinyl-based copolymer according to Example 2.

FIG. 4 is a transmission electron microscope (TEM) photograph of a blend composition of a polycarbonate resin and a vinyl-based copolymer according to Example 3.

FIG. 5 is a graph showing viscosity measurements according to shear force about a blend composition of a polycarbonate resin and a vinyl-based copolymer of Examples 2 and 4 and Comparative Example 1.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

When a specific definition is not otherwise provided, the term “substituted” refers to one substituted with a substituent of halogen, C1 to C30 alkyl, C1 to C30 haloalkyl, C6 to C30 aryl, C2 to C30 heteroaryl, C1 to C20 alkoxy, or a combination thereof.

When a specific definition is not otherwise provided, the term “heterocyclic monomer” refers to a cyclic compound monomer including at least one or more heteroatoms selected from N, O, S, P, or a combination thereof.

When a specific definition is not otherwise provided, the term “different kinds” refers to monomers different from each other. For example, the term “different kinds of acrylic-based monomer” refers to acrylic-based monomers different from each other, the term “different kinds of aromatic vinyl monomer” refers to aromatic vinyl monomers different from each other, and the term “different kinds of heterocyclic monomer” refers to heterocyclic monomers different from each other.

The blend composition of a polycarbonate resin and a vinyl-based copolymer according to one embodiment includes (A) a mixed resin including (A-1) a polycarbonate resin and (A-2) a vinyl-based copolymer, and (B) an acrylic-based copolymer including at least one acrylic-based monomer.

Exemplary components included in the blend composition of a polycarbonate resin and a vinyl-based copolymer according to various embodiments will hereinafter be described in detail. However, these embodiments are exemplary, and this disclosure is not limited thereto.

(A) Mixed Resin

(A-1) Polycarbonate Resin

The polycarbonate resin may be prepared by reacting one or more diphenols of the following Chemical Formula 1 with a compound of phosgene, halogen formate, carbonate ester, or a combination thereof.

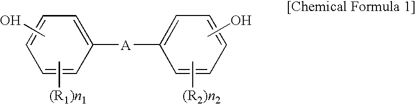

In the above Chemical Formula 1,

A is a linker comprising a single bond, substituted or unsubstituted C1 to C30 linear or branched alkylene, substituted or unsubstituted C2 to C5 alkenylene, substituted or unsubstituted C2 to C5 alkylidene, substituted or unsubstituted C1 to C30 linear or branched haloalkylene, substituted or unsubstituted C5 to C6 cycloalkylene, substituted or unsubstituted C5 to C6 cycloalkenylene, substituted or unsubstituted C5 to C10 cycloalkylidene, substituted or unsubstituted C6 to C30 arylene, substituted or unsubstituted C1 to C20 linear or branched alkoxylene, halogen acid ester, carbonate ester, CO, S, or SO₂,

each of R₁ and R₂ independently comprises substituted or unsubstituted C1 to C30 alkyl or substituted or unsubstituted C6 to C30 aryl, and

n₁ and n₂ are independently integers ranging from 0 to 4.

The diphenols represented by the above Chemical Formula 1 may be used in combination to constitute repeating units of the polycarbonate resin. Exemplary diphenols include without limitation hydroquinone, resorcinol, 4,4′-dihydroxydiphenyl, 2,2-bis(4-hydroxyphenyl)propane (referred to as “bisphenol-A”), 2,4-bis(4-hydroxyphenyl)-2-methylbutane, bis(4-hydroxyphenyl)methane, 1,1-bis(4-hydroxyphenyl)cyclohexane, 2,2-bis(3-chloro-4-hydroxyphenyl)propane, 2,2-bis(3,5-dimethyl-4-hydroxyphenyl)propane, 2,2-bis(3,5-dichloro-4-hydroxyphenyl)propane, 2,2-bis(3,5-dibromo-4-hydroxyphenyl)propane, bis(4-hydroxyphenyl)sulfoxide, bis(4-hydroxyphenyl)ketone, bis(4-hydroxyphenyl)ether, and the like, and combinations thereof. In one embodiment, 2,2-bis(4-hydroxyphenyl)-propane, 2,2-bis(3,5-dichloro-4-hydroxyphenyl)-propane, or 1,1-bis(4-hydroxyphenyl)-cyclohexane of the diphenols may be used. In another embodiment, 2,2-bis(4-hydroxyphenyl)-propane may be used.

In one embodiment, the polycarbonate resin can have a weight average molecular weight ranging from about 10,000 to about 200,000 g/mol, and in another embodiment, from about 15,000 to about 80,000 g/mol.

The polycarbonate resin may be a mixture of copolymers obtained using two or more diphenols that are different from each other. The polycarbonate resin may be a linear polycarbonate resin, a branched polycarbonate resin, a polyester carbonate copolymer, and the like, or a combination thereof.

The linear polycarbonate resin may include a bisphenol-A-based polycarbonate resin. The branched polycarbonate resin may be produced by reacting a multi-functional aromatic compound such as trimellitic anhydride, trimellitic acid, and the like with diphenols and a carbonate. The multi-functional aromatic compound may be included in an amount of about 0.05 to about 2 mol % based on the total weight of the branched polycarbonate resin. The polyester carbonate copolymer resin may include one produced by reacting a difunctional carboxylic acid with diphenols and a carbonate. The carbonate may include a diaryl carbonate such as diphenyl carbonate, and ethylene carbonate.

The mixed resin including the polycarbonate resin and the vinyl-based copolymer may include the polycarbonate resin in an amount of about 10 to about 90 wt %, for example about 20 to about 60 wt %, based on the total weight of the mixed resin including the polycarbonate resin and vinyl-based copolymer. When the polycarbonate resin is included within these ranges, the blend composition may have an excellent property balance between impact strength, heat resistance and workability.

(A-2) Vinyl-Based Copolymer

The vinyl-based copolymer includes a rubber-modified vinyl-based graft copolymer, a linear vinyl-based copolymer, or a combination thereof.

The rubber modified vinyl-based graft copolymer may be prepared by grafting about 5 to about 95 wt % of a vinyl-based polymer onto about 5 to about 95 wt % of a rubber polymer.

The vinyl-based polymer may include about 50 to about 95 wt % of a first vinyl-based monomer comprising an aromatic vinyl monomer, an acrylic-based monomer, a heterocyclic monomer, or a combination thereof; and about 5 to about 50 wt % of a second vinyl-based monomer selected from an unsaturated nitrile monomer, an acrylic-based monomer, a heterocyclic monomer, or a combination thereof.

Exemplary aromatic vinyl monomers may include without limitation styrene, C1 to C10 alkyl substituted styrene, halogen substituted styrene, and the like, and combinations thereof. Exemplary alkyl substituted styrene may include without limitation o-ethyl styrene, m-ethyl styrene, p-ethyl styrene, a-methyl styrene, and the like, and combinations thereof.

Exemplary acrylic-based monomers may include without limitation (meth)acrylic acid alkyl esters, (meth)acrylic acid esters, and the like, and combinations thereof. As used herein with reference to the (meth)acrylic acid alkyl esters, the term alkyl can include C1 to C10 alkyl. Exemplary (meth)acrylic acid alkyl esters may include without limitation methyl(meth)acrylate, ethyl(meth)acrylate, propyl(meth)acrylate, butyl(meth)acrylate, and the like and combinations thereof. Exemplary (meth)acrylic acid esters may include without limitation (meth)acrylate, and the like, and combinations thereof.

The heterocyclic monomer may be substituted or non-substituted C2 to C20 cycloalkyl compound, substituted or non-substituted C2 to C20 cycloalkenyl compound, or substituted or non-substituted C2 to C20 cycloalkynyl compound. Exemplary heterocyclic monomers may include without limitation maleic anhydride, alkyl or phenyl N-substituted maleimide, and the like, and combinations thereof.

Exemplary unsaturated nitrile monomers may include without limitation acrylonitrile, methacrylonitrile, ethacrylonitrile, and the like, and combinations thereof.

Exemplary rubber polymers may include without limitation butadiene rubber, acrylic rubbers, ethylene/propylene rubbers, styrene/butadiene rubbers, acrylonitrile/butadiene rubbers, isoprene rubbers, ethylene-propylene-diene terpolymer (EPDM) rubbers, polyorganosiloxane/polyalkyl(meth)acrylate rubber composites, and the like, and combinations thereof.

The rubber modified vinyl-based graft copolymer may be prepared by using a rubber having a particle diameter ranging from 0.05 to 4 μm to improve impact resistance and surface characteristics of a molded product. When the rubber has a particle diameter ranging from 0.05 to 4 μm, it can provide excellent impact strength.

The rubber modified vinyl-based graft copolymer may be used singly or as a combination or mixture of more than two.

Examples of the rubber modified vinyl-based graft copolymer may be prepared by graft-copolymerizing styrene, acrylonitrile and optionally methyl(meth)acrylate into a butadiene rubber, an acrylic rubber, or a styrene/butadiene rubber as a mixture.

Another example of the rubber modified vinyl-based graft copolymer may be prepared by graft-copolymerizing methyl(meth)acrylate onto a butadiene rubber, an acrylic rubber, or a styrene/butadiene rubber.

The particular examples of a rubber modified graft copolymer may include an acrylonitrile-butadiene-styrene (ABS) copolymer.

Methods of preparing the rubber modified vinyl-based graft copolymer are well-known to those of ordinary skill in this art and can be selected from emulsion polymerization, suspension polymerization, solution polymerization, or bulk polymerization. For example, the rubber modified vinyl-based graft copolymer may be prepared by emulsion polymerization or bulk polymerization using a polymerization initiator by injecting the aforementioned aromatic vinyl monomer in a rubber polymer.

The linear vinyl-based copolymer may include a first vinyl-based monomer comprising an aromatic vinyl monomer, an acrylic-based monomer, a heterocyclic monomer, or a combination thereof; and a second vinyl-based monomer comprising an unsaturated nitrile monomer, an acrylic-based monomer, a heterocyclic monomer, or a combination thereof.

Exemplary aromatic vinyl monomers may include without limitation styrene, C1 to C10 alkyl substituted styrene, halogen substituted styrene, and the like, and combinations thereof. Exemplary alkyl substituted styrenes may include without limitation o-ethyl styrene, m-ethyl styrene, p-ethyl styrene, a-methyl styrene, and the like, and combinations thereof.

Exemplary acrylic-based monomers may include without limitation (meth)acrylic acid alkyl esters, (meth)acrylic acid esters, and the like and combinations thereof. As used herein, the term alkyl when used with reference to the (meth)acrylic acid alkyl esters can include a C1 to C10 alkyl. Exemplary (meth)acrylic acid alkyl esters may include without limitation methyl(meth)acrylate, ethyl(meth)acrylate, propyl(meth)acrylate, butyl(meth)acrylate, and the like, and combinations thereof. Exemplary (meth)acrylic acid esters may include without limitation (meth)acrylate, and the like, and combinations thereof.

The heterocyclic monomer may be substituted or non-substituted C2 to C20 cycloalkyl compound, substituted or non-substituted C2 to C20 cycloalkenyl compound, or substituted or non-substituted C2 to C20 cycloalkynyl compound. Exemplary heterocyclic monomers may include without limitation maleic anhydride, alkyl or phenyl N-substituted maleimide, and the like, and combinations thereof.

Exemplary unsaturated nitrile monomers include without limitation acrylonitrile, methacrylonitrile, ethacrylonitrile, and the like, and combinations thereof.

The linear vinyl-based copolymer may include about 50 to about 95 wt % of the first vinyl-based monomer and about 5 to about 50 wt % of the second vinyl-based monomer. When first vinyl-based monomer and the second vinyl-based monomer are mixed within this ratio, the linear vinyl-based copolymer may improve thermal coloring and chemical resistance.

The linear vinyl-based copolymer may be produced as a byproduct when the rubber modified vinyl-based graft copolymer is prepared. In particular, it may be produced when a vinyl-based monomer mixture is used in an excess amount and grafted onto a small amount of a rubber polymer or when an excess amount of a chain-transfer agent for controlling a molecular weight is used.

Examples of the linear vinyl-based copolymer may include a monomer mixture of styrene, acrylonitrile, and optionally methylmethacrylate; a monomer mixture of α-methylstyrene, acrylonitrile, and optionally methylmethacrylate; or a monomer mixture of styrene, α-methylstyrene, acrylonitrile, and optionally methylmethacrylate.

The linear vinyl-based copolymer may be prepared by emulsion polymerization, suspension polymerization, solution polymerization, or bulk polymerization. It may have a weight average molecular weight ranging from about 15,000 to about 300,000 g/mol.

Another example of the linear vinyl-based copolymer may include a mixture of methylmethacrylate and optionally methylacrylate. This linear vinyl-based copolymer may be prepared by emulsion polymerization, suspension polymerization, solution polymerization or bulk polymerization and may have a weight average molecular weight ranging from about 20,000 to about 250,000 g/mol.

Still another example of the linear vinyl-based copolymer may include a copolymer of styrene and maleic anhydride and can be prepared by consecutive massive polymerization and solution polymerization. The styrene and the maleic anhydride may be mixed within a wide ratio range. In particular, the maleic anhydride may be included in an amount of about 5 to about 50 wt % based on the total weight of the vinyl-based copolymer. The styrene and the maleic anhydride copolymer may have a weight average molecular weight over a wide range. In particular, it may have a weight average molecular weight ranging from about 20,000 to about 200,000 g/mol and an intrinsic viscosity ranging from about 0.3 to about 0.9 dl/g.

The vinyl-based copolymer may be prepared by mixing the rubber modified vinyl-based graft copolymer and the linear vinyl-based copolymer.

The mixed resin including the polycarbonate resin and the vinyl-based copolymer may include the vinyl-based copolymer in an amount of about 10 to about 80 wt %, for example about 20 to about 70 wt %, based on the total weight of the mixed resin including the polycarbonate resin and the vinyl-based copolymer. When the vinyl-based copolymer is included in an amount within the range, it may improve impact resistance, flame retardant, and heat resistance.

(B) Acrylic-Based Copolymer

The acrylic-based copolymer may activate inter molecular diffusion and improve miscibility between a polycarbonate resin and a vinyl-based copolymer when they are mixed. In this way, it may effectively decrease the phase separation between the polycarbonate resin and the vinyl-based copolymer and thereby improve weld strength.

The acrylic-based copolymer includes more than one acrylic-based monomer and may be prepared by copolymerizing a first monomer comprising an aromatic vinyl monomer, an acrylic-based monomer, a heterocyclic monomer, or a combination thereof; and a second monomer comprising another aromatic vinyl monomer that is different from the first aromatic vinyl monomer, another acrylic-based monomer that is different from the first acrylic-based monomer, another heterocyclic monomer that is different from the first heterocyclic monomer, or a combination thereof. At least one of the first or second monomer may include an acrylic-based monomer. For example, the acrylic-based copolymer may be a copolymer of an acrylic-based monomer and another acrylic-based monomer that is different from the first acrylic-based monomer. An exemplary acrylic-based copolymer is a copolymer of methylmethacrylate and ethylacrylate.

The acrylic-based copolymer may be copolymerized by grafting the first monomer onto the second monomer. The grafted copolymer may have better impact strength.

Exemplary aromatic vinyl monomers may include without limitation styrene, C1 to C10 alkyl substituted styrene, halogen substituted styrene, and the like, and combinations thereof. Exemplary alkyl substituted styrenes may include without limitation o-ethyl styrene, m-ethyl styrene, p-ethyl styrene, a-methyl styrene, and the like, and combinations thereof.

Exemplary acrylic-based monomers may include without limitation (meth)acrylic acid alkyl esters, (meth)acrylic acid esters, and the like, and combinations thereof. As used herein with reference to the (meth)acrylic acid alkyl ester, the term alkyl can include a C1 to C10 alkyl. Exemplary (meth)acrylic acid alkyl esters may include without limitation methyl(meth)acrylate, ethyl(meth)acrylate, propyl(meth)acrylate, butyl(meth)acrylate, and the like, and combinations thereof. Exemplary (meth)acrylic acid esters may include without limitation (meth)acrylate, and the like, and combinations thereof.

The heterocyclic monomer may be substituted or non-substituted C2 to C20 cycloalkyl compound, substituted or non-substituted C2 to C20 cycloalkenyl compound, or substituted or non-substituted C2 to C20 cycloalkynyl compound. Exemplary heterocyclic monomers may include without limitation maleic anhydride, alkyl or phenyl N-substituted maleimide, and the like, and combinations thereof.

The acrylic-based copolymer may include about 30 to about 90 wt % of the first monomer and about 10 to about 70 wt % of the second monomer. When it includes the first monomer and the second monomer in an amount within this ratio, the acrylic-based copolymer may improve miscibility between the polycarbonate resin and the vinyl-based copolymer.

The acrylic-based copolymer may be prepared by emulsion polymerization, suspension polymerization, solution polymerization, or bulk polymerization and can have a weight average molecular weight ranging from about 100,000 to about 30,000,000 g/mol, for example about 1,000,000 to about 30,000,000 g/mol, as another example about 1,000,000 to about 10,000,000 g/mol, and as another example about 1,000,000 to about 7,000,000 g/mol. When the acrylic-based copolymer has a weight average molecular weight within these ranges, it may not damage on fluidity at a shear speed region during the injection and secure stable morphology among the composition components.

The acrylic-based copolymer may be used singly or as a combination or mixture of more than two.

The blend composition of a polycarbonate resin and a vinyl-based copolymer may include the acrylic-based copolymer in an amount of about 0.1 to about 20 parts by weight, for example about 0.5 to about 18 parts by weight, and as another example about 1 to about 15 parts by weight, based on about 100 parts by weight of a mixed resin including the polycarbonate resin and the vinyl-based copolymer. When the acrylic-based copolymer is included in an amount within these ranges, it may accomplish excellent impact resistance and heat resistance.

(C) Core-Shell Graft Copolymer Including an Acrylic-Based Shell

According to one exemplary embodiment, a blend composition of a polycarbonate resin and a vinyl-based copolymer may further include a core-shell graft copolymer.

The core-shell graft copolymer works as an impact-reinforcing agent in a polycarbonate-based thermoplastic resin composition.

The core-shell graft copolymer has a core-shell structure including a hard shell formed by grafting an unsaturated monomer onto a rubber core and may be a copolymer prepared by grafting an unsaturated compound comprising an acrylic-based monomer, a heterocyclic monomer, an aromatic vinyl monomer, an unsaturated nitrile monomer, or a combination thereof onto a rubber polymer polymerized from a monomer comprising a diene-based monomer, an acrylic-based monomer, a silicon-based monomer, or a combination thereof. The unsaturated compound includes at least one acrylic-based monomer.

The diene-based monomer may include C4 to C6 butadiene, isoprene, and the like and combinations thereof, for example, butadiene. Exemplary rubber polymers polymerized from the diene-based monomer may include without limitation a butadiene rubber, an acrylic rubber, a styrene/butadiene rubber, an acrylonitrile/butadiene rubber, an isoprene rubber, an ethylene-propylene-diene terpolymer (EPDM), and the like, and combinations thereof.

Exemplary acrylic-based monomers may include without limitation methyl(meth)acrylate, ethyl(meth)acrylate, n-propyl(meth)acrylate, n-butyl(meth)acrylate, hexyl(meth)acrylate, 2-ethylhexyl(meth)acrylate, and the like, and combinations thereof. As used herein, a hardener (or curing agent) may also be used, such as but not limited to ethylene glycol di(meth)acrylate, propylene glycol di(meth)acrylate, 1,3-butylene glycol di(meth)acrylate, 1,4-butylene glycol di(meth)acrylate, allyl(meth)acrylate, triallylcyanurate, and the like, and combinations thereof.

Exemplary silicon-based monomers may include without limitation hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrasiloxane, octaphenylcyclotetrasiloxane, and the like, and combinations thereof. A hardener (or curing agent) may also be included, such as but not limited to trimethoxymethylsilane, triethoxyphenylsilane, tetramethoxysilane, tetraethoxysilane, and the like, and combinations thereof.

The rubber polymer may have a rubber average particle diameter ranging from about 0.4 to about 1 μm and can maintain impact resistance and coloring balance.

Among the unsaturated compounds, an acrylic-based monomer may include (meth)acrylic acid alkyl ester, (meth)acrylic acid ester, or a combination thereof. As used herein, reference to the alkyl of the (meth)acrylic acid alkyl ester may be a C1 to C10 alkyl. Exemplary (meth)acrylic acid alkyl esters may include without limitation methyl(meth)acrylate, ethyl(meth)acrylate, propyl(meth)acrylate, butyl(meth)acrylate, and the like, and combinations thereof, for example, methyl(meth)acrylate. Exemplary (meth)acrylic acid esters may include without limitation (meth)acrylate, and the like, and combinations thereof.

The heterocyclic monomer may be substituted or non-substituted C2 to C20 cycloalkyl compound, substituted or non-substituted C2 to C20 cycloalkenyl compound, or substituted or non-substituted C2 to C20 cycloalkynyl compound. Exemplary heterocyclic monomers may include without limitation maleic anhydride, alkyl or phenyl N-substituted maleimide, and the like, and combinations thereof.

Exemplary aromatic vinyl monomers may include without limitation styrene, C1 to C10 alkyl substituted styrene, halogen substituted styrene, and the like, and combinations thereof. Exemplary alkyl substituted styrenes may include without limitation o-ethyl styrene, m-ethyl styrene, p-ethyl styrene, a-methyl styrene, and the like, and combinations thereof.

Exemplary unsaturated nitrile monomers may include without limitation acrylonitrile, methacrylonitrile, ethacrylonitrile, and the like, and combinations thereof.

Among the unsaturated compounds, a polymer prepared from more than one monomer may include polymethylmethacrylate and the like.

The core-shell copolymer may have an average particle size ranging from about 0.1 to about 0.5 μm. When the core-shell copolymer has an average particle size within this range, it may be well-dispersed into a blend composition of a polycarbonate resin and a vinyl-based copolymer. When the blend composition of a polycarbonate resin and a vinyl-based copolymer including the core-shell copolymer is subject to an exterior impact, it may easily absorb the impact, to thereby increase impact reinforcing effects.

The core-shell copolymer may include about 30 to about 70 wt % of the rubber polymer and about 30 to about 70 wt % of an unsaturated compound grafted thereonto. When the core-shell copolymer includes the rubber polymer and the unsaturated compound in an amount within this ratio, it may have good compatibility with a polycarbonate resin, maximizing impact reinforcing effects.

The blend composition of a polycarbonate resin and a vinyl-based copolymer may include the core-shell graft copolymer in an amount of about 1 to about 20 parts by weight, for example about 5 to about 15 parts by weight, based on about 100 parts by weight of a mixed resin including the polycarbonate resin and the vinyl-based copolymer. When it is included within these ranges, the core-shell graft copolymer may bring about excellent impact reinforcing effects and improve mechanical strength of a blend composition of a polycarbonate resin and a vinyl-based copolymer such as tensile strength, flexural strength, and flexural modulus.

(D) Other Additive(s)

Accordingly to one present exemplary embodiment, a blend composition of a polycarbonate resin and a vinyl-based copolymer may further include one or more additives.

Exemplary additives may include without limitation antibacterial agents, heat stabilizers, antioxidants, release agents, light stabilizers, compatibilizers, inorganic material additives, surfactants, coupling agents, plasticizers, admixtures, stabilizers, lubricants, antistatic agents, flame-proofing agents, weather-resistance agents, colorants, ultraviolet (UV) blocking agents, filler, nucleating agents, adhesion aids, adhesives, and the like, and combinations thereof.

Exemplary antioxidants may include without limitation phenol-type antioxidants, phosphite-type antioxidants, thioether-type antioxidants, amine-type antioxidants, and the like, and combinations thereof. Exemplary release agents may include without limitation fluorine-containing polymers, silicone oils, metal salts of stearic acid, metal salts of montanic acid, montanic acid ester waxes, polyethylene waxes, and the like, and combinations thereof. Exemplary weather-resistance agents may include without limitation benzophenone-type weather-resistance agents, amine-type weather-resistance agents, and the like, and combinations thereof. Exemplary colorants may include without limitation dyes, pigments, and the like, and combinations thereof. Exemplary ultraviolet (UV) blocking agents may include without limitation titaium oxide (TiO₂), carbonblack, and the like, and combinations thereof. Exemplary filler may include glass fiber, carbon fiber, silica, mica, alumina, clay, calcium carbonate, calcium sulfate, glass beads, and the like, and combinations thereof. When the filler is included, it may improve properties such as mechanical strength, heat resistance, and the like. Exemplary nucleating agents may include without limitation talc, clay, and the like, and combinations thereof.

The additive may be included in an amount of about 40 parts by weight or less, for example about 0.1 to about 20 parts by weight, based on about 100 parts by weight of a mixed resin including the polycarbonate resin and the vinyl-based copolymer. When an additive is included in an amount within these ranges, it may bring about a desired effect depending on each usage and improve mechanical properties and surface appearance.

According to one exemplary embodiment, a blend composition of a polycarbonate resin and a vinyl-based copolymer may be prepared using any well-known method of preparing a resin composition. For example, the components and optionally other additives can be simultaneously mixed together and then melt-extruded in an extruder to prepare into pellets.

According to another embodiment, a blend composition of a polycarbonate resin and a vinyl-based copolymer may be molded to produce a product. The blend composition of a polycarbonate resin and a vinyl-based copolymer may be used for a molded product requiring weld strength, durability, and heat resistance, for example, auto parts, machine parts, electric/electronic parts, office machines such as a computers and the like. In particular, it may be used to manufacture housings for electric/electronic goods such as televisions, computers, printers, washing machines, cassette players, audio equipments, mobile phones, and the like. It may also be used for electric/electronic housings requiring complex molding of a thin film, computer housings, other office machines, and the like.

Hereinafter, exemplary embodiments are illustrated. However, the following exemplary embodiments are provided for illustration only and do not limit this disclosure.

### EXAMPLE

According to an exemplary embodiment, the blend composition of a polycarbonate resin and a vinyl-based copolymer may include each component as follows.

(A) Mixed Resin

(A-1) Polycarbonate Resin

A bisphenol-A type polycarbonate (Cheil Industries Inc., SC-1080) with a weight average molecular weight (Mw) of 25,000 g/mol is used.

(A-2) Vinyl-Based Copolymer

(A-2-1) A copolymer is prepared by copolymerizing 31.5 wt % of styrene, 10.5 wt % of acrylonitrile, and 58 wt % of butadiene. The copolymer is washed, dehydrated, and dried, preparing a powder-typed ABS (acrylonitrile-butadiene-styrene) copolymer.

(A-2-2) A SAN copolymer is prepared by mixing 71 parts by weight of styrene, 29 parts by weight of acrylonitrile, and 120 parts by weight of deionized water, 0.17 parts by weight of azobisisobutyronitrile, 0.4 parts by weight of t-dodecyl mercaptan, and 0.5 parts by weight of tricalciumphosphate to the mixture, and suspension-polymerizing the resulting mixture at 75° C. for 5 hours. This copolymer is washed, dehydrated, and dried, preparing a powder-typed SAN copolymer.

(B) Acrylic-Based Copolymer

A graft copolymer of poly(methylmethacrylate-ethylacrylate) with a weight average molecular weight of 3,000,000 g/mol (Rohm and Haas Co., K125P) is used.

(B′) Polymethylmethacrylate (PMMA) Polymer

A polymethylmethacrylate (PMMA) polymer with a weight average molecular weight of 80,000 g/mol is used for the Comparative Example.

(C) Core-Shell Graft Copolymer Including an Acrylic-Based Shell

A methacrylate-butadiene-styrene (MBS Co.) impact-reinforcing agent (MRC Co., C223A) including 70 wt % of butadiene is used as a copolymer including a butadiene core and a methacrylate-styrene shell grafted thereinto.

### Examples 1 to 8 and Comparative Examples 1 to 3

Each aforementioned component is put in a mixer in an amount as shown in the following Table 1, mixed together, and extruded using a twin-screw extruder set to be L/D=35 and φ=45 mm at 260° C. of a nozzle temperature, preparing a pellet. The pellet is dried at 80° C. for 5 hours before injection molding.

A specimen for evaluating properties is prepared using a 10 oz injector at a temperature of 250° C. Another specimen for measuring weld strength is prepared using a 10 oz injector at a temperature of 250° C.

### Experimental Example

The specimens according to Examples 1 to 8 and Comparative Examples 1 to 3 are allowed to stand at 23° C. and a relative humidity degree (RHD) of 50% for 48 hours and the properties thereof are evaluated in accordance with the following methods. The results are shown in the following Table 1.

(1) Izod impact strength: Izod impact strength (¼″, ⅛″ notch) is measured according to ASTM D256.

(2) Weld impact strength: Izod impact strength (⅛″) is measured according to ASTM D256, after a weld is formed in the middle of the specimens through both side gates.

(3) Flow index: measured at 250° C. under a condition of 10 kg according to ASTM D1238.

(4) Spiral 1 t (270° C.): measured at a barrel temperature of 270° C. and a molding temperature of 70° C.

TABLE 1

| | | | | | | | | | | | Comparative | | |
|---|---|---|---|---|---|---|---|---|---|---|---|---|---|
| | | | Example | | | | | | | | Example | | |
| | | | 1 | 2 | 3 | 4 | 5 | 6 | 7 | 8 | 1 | 2 | 3 |
| (A) | A-1 | | 65 | 65 | 65 | 65 | 65 | 55 | 60 | 65 | 65 | 65 | 47 |
| mixed | polycarbonate | | | | | | | | | | | | |
| resin | resin (wt %) | | | | | | | | | | | | |
| | A-2 | A-2-1 | 35 | 35 | 35 | 35 | 35 | 20 | 20 | 15 | 35 | 35 | 11 |
| | vinyl- | A-2-2 | — | — | — | — | — | 25 | 20 | 20 | — | — | 13 |
| | based | | | | | | | | | | | | |
| | copolymer | | | | | | | | | | | | |
| | (wt %) | | | | | | | | | | | | |

| (B) acrylic-based | | 1 | 3 | 5 | 8 | 15 | 5 | 3 | 8 | — | — | 25 |
|---|---|---|---|---|---|---|---|---|---|---|---|---|
| copolymer | | | | | | | | | | | | |
| (parts by weight*) | | | | | | | | | | | | |
| (B′) PMMA polymer | | — | — | — | — | — | — | — | — | — | 8 | — |
| (parts by weight*) | | | | | | | | | | | | |
| (C) core-shell graft | | — | — | — | — | — | 8 | 5 | 3 | — | — | 4 |
| copolymer | | | | | | | | | | | | |
| (parts by weight*) | | | | | | | | | | | | |
| Izod | ¼″ | 45 | 45 | 46 | 45 | 42 | 48 | 46 | 45 | 38 | 38 | 28 |
| impact | ⅛″ | 65 | 64 | 64 | 62 | 59 | 58 | 60 | 57 | 54 | 54 | 47 |
| strength | | | | | | | | | | | | |
| (kgf · cm/cm) | | | | | | | | | | | | |

| | | | | | | | | | | | |
|---|---|---|---|---|---|---|---|---|---|---|---|
| Weld impact | 18 | 16 | 20 | 27 | 18 | 21 | 24 | 26 | 11 | 10 | 33 |
| strength | | | | | | | | | | | |
| (⅛″, kgf · cm/cm) | | | | | | | | | | | |
| Flow index | 35 | 30 | 26 | 20 | 15 | 18 | 32 | 17 | 35 | 40 | 2 |
| (g/10 min) | | | | | | | | | | | |
| Spiral 1t (270° C.) | 170 | 169 | 169 | 169 | 168 | 152 | 173 | 155 | 171 | 174 | 160 |

*parts by weight: based on 100 parts of weight of a mixed resin (A).

Referring to Table 1, Examples 1 to 8 including a polycarbonate resin, a vinyl-based copolymer, and an acrylic-based copolymer including at least one acrylic-based monomer have excellent weld strength and impact resistance compared with Comparative Example 1 including no acrylic-based copolymer and Comparative Examples 2 and 3 including a PMMA copolymer instead of the acrylic-based copolymer. It is currently believed that adding the acrylic-based copolymer to the blend composition of a polycarbonate resin and a vinyl-based copolymer decreases phase separation of the polycarbonate resin and the vinyl-based copolymer.

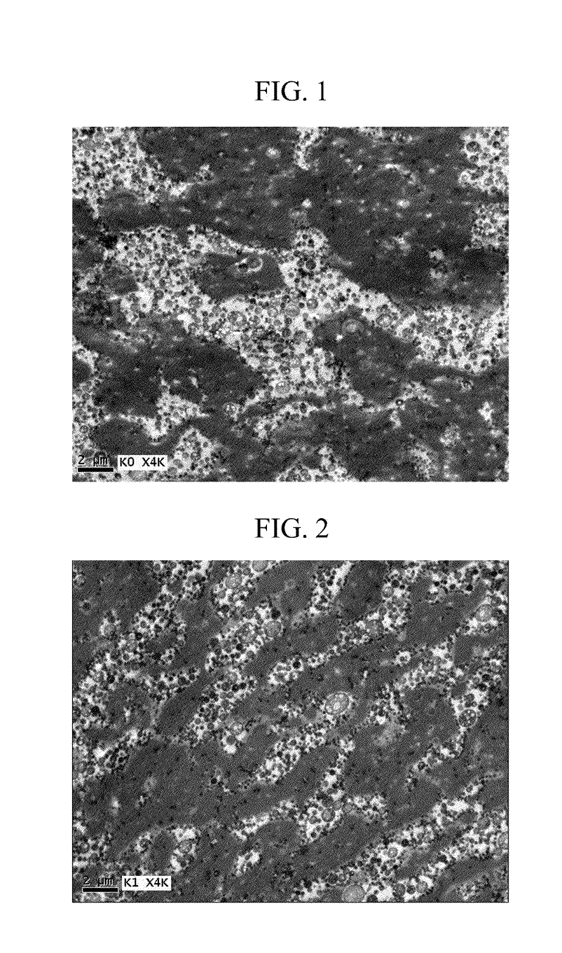

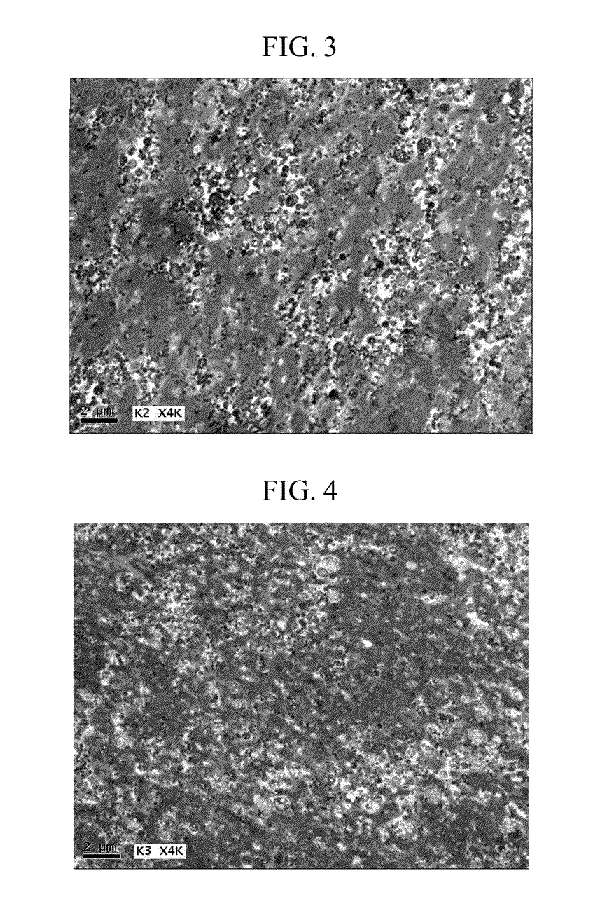

This result is also identified in FIGS. 1 to 4. FIG. 1 provides the transmission electron microscope (TEM) photograph of the blend composition of a polycarbonate resin and a vinyl-based copolymer according to Comparative Example 1. FIGS. 2 to 4 respectively provide the transmission electron microscope (TEM) photograph of the blend composition of a polycarbonate resin and a vinyl-based copolymer according to Examples 1 to 3. Referring to FIGS. 1 to 4, while Comparative Example 1 including no acrylic-based copolymer has severe phase separation, Examples 1 to 3 have decreased phase separation currently believed due to the addition of an acrylic-based copolymer. In this way, the phase separation at a weld region where two kinds of resins meet (join) can be reduced to increase impact strength at the weld.

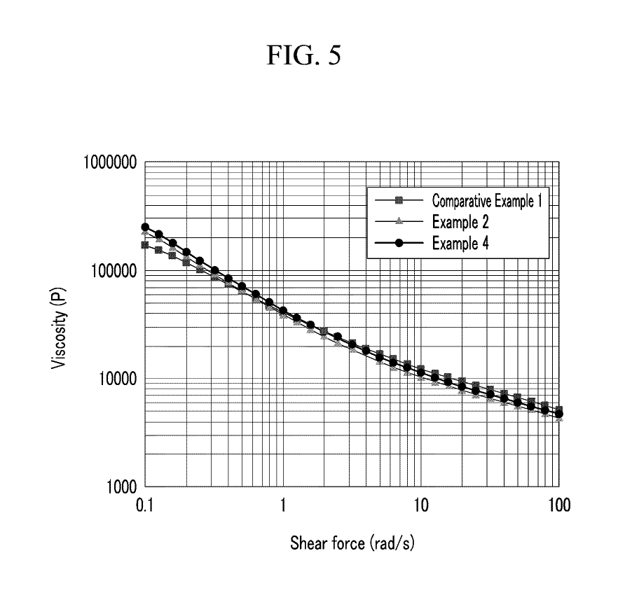

FIG. 5 is a graph showing viscosity measurements of the blend composition of a polycarbonate resin and a vinyl-based copolymer of Examples 2 and 4 and Comparative Example 1 according to shear force. The viscosity is measured at a temperature of 270° C. and strain of 5% with a dynamic frequency sweep.

Referring to FIG. 5, the blend compositions of a polycarbonate resin and a vinyl-based copolymer according to Examples 2 and 4 have high viscosity at a region with low shear force. Accordingly, the blends can prevent coalescence of dispersive phases. In addition, the blend compositions of a polycarbonate resin and a vinyl-based copolymer of Examples 2 and 4 have almost the same viscosity at the region with high shear force. Accordingly, when these two resins are welded, they can maintain high impact strength with no phase separation. On the other hand, Comparative Example 1 including no acrylic-based copolymer or including a PMMA polymer instead of the acrylic-based copolymer have low viscosity at a region with low shear force, and thus do not substantially prevent coalescence effects.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A blend composition of a polycarbonate resin and a vinyl-based copolymer comprising
(A) a mixed resin including (A-1) about 20 to about 90 wt % of a polycarbonate resin; and (A-2) about 10 to about 80 wt % of a vinyl-based copolymer; and
(B) about 0.1 to about 20 parts by weight of an acrylic-based copolymer including at least one acrylic-based monomer based on about 100 parts by weight of the mixed resin.

2. The blend composition of claim 1, wherein the polycarbonate resin is prepared by reacting one or more diphenols with a compound of phosgene, halogen formate, carbonate ester, or a combination thereof.

3. The blend composition of claim 1, wherein the vinyl-based copolymer (A-2) comprises a rubber modified vinyl-based graft copolymer, a linear vinyl-based copolymer, or a combination thereof.

4. The blend composition of claim 3, wherein the rubber modified vinyl-based graft copolymer comprises
about 5 to about 95 wt % of a vinyl-based polymer including about 50 to about 95 wt % of a first vinyl-based monomer comprising an aromatic vinyl monomer, an acrylic-based monomer, a heterocyclic monomer, or a combination thereof; and about 5 to about 50 wt % of second vinyl-based monomer comprising an unsaturated nitrile monomer, an acrylic-based monomer, a heterocyclic monomer, or a combination thereof, which is grafted onto about 5 to about 95 wt % of a rubber polymer comprising a butadiene rubber, an acrylic rubber, an ethylene/propylene rubber, a styrene/butadiene rubber, an acrylonitrile/butadiene rubber, an isoprene rubber, an ethylene-propylene-diene (EPDM) terpolymer, a polyorganosiloxane/polyalkyl(meth)acrylate rubber composite, or a combination thereof.

5. The blend composition of claim 3, wherein the linear vinyl-based copolymer comprises a copolymer of about 50 to about 95 wt % of a first vinyl-based monomer comprising an aromatic vinyl monomer, an acrylic-based monomer, a heterocyclic monomer, or a combination thereof; and about 5 to about 50 wt % of a second vinyl-based monomer comprising an unsaturated nitrile monomer, an acrylic-based monomer, a heterocyclic monomer, or a combination thereof.

6. The blend composition of claim 1, wherein the acrylic-based copolymer (B) comprises
a copolymer of about 30 to about 90 wt % of a first monomer comprising an aromatic vinyl monomer, an acrylic-based monomer, a heterocyclic monomer, or a combination thereof; and about 10 to about 70 wt % of a second monomer comprising an aromatic vinyl monomer comprising an aromatic vinyl monomer that is different from the first aromatic vinyl monomer, an acrylic-based monomer that is different from the first acrylic-based monomer, a heterocyclic monomer that is different from the first heterocyclic monomer, or a combination thereof,
wherein at least one of the first monomer and the second monomer is an acrylic-based monomer.

7. The blend composition of claim 6, wherein the acrylic-based copolymer (B) includes the first monomer grafted and copolymerized with the second monomer.

8. The blend composition of claim 1, wherein the acrylic-based copolymer (B) is a copolymer of an acrylic-based monomer and another acrylic-based monomer that is different from the first acrylic-based monomer.

9. The blend composition of claim 1, wherein the acrylic-based copolymer (B) is a copolymer of methylmethacrylate and ethylacrylate.

10. The blend composition of claim 1, wherein the acrylic-based copolymer (B) has a weight average molecular weight ranging from about 100,000 to about 30,000,000 g/mol.

11. The blend composition of claim 1, wherein the acrylic-based copolymer (B) has a weight average molecular weight ranging from about 1,000,000 to about 30,000,000 g/mol.

12. The blend composition of claim 1, which further comprises (C) about 1 to about 20 parts by weight of a core-shell graft copolymer comprising an acrylic-based shell based on about 100 parts by weight of the mixed resin.

13. The blend composition of claim 12, wherein the core-shell graft copolymer comprising an acrylic-based shell (C) is a copolymer prepared by grafting an unsaturated compound comprising an acrylic-based monomer, a heterocyclic monomer, an aromatic vinyl monomer, an unsaturated nitrile monomer, or a combination thereof into a rubber polymer polymerized from a monomer comprising a diene-based monomer, an acrylic-based monomer, a silicon-based monomer, or a combination thereof, and wherein the unsaturated compound comprises at least one acrylic-based monomer.

14. The blend composition of claim 1, which further comprises an antibacterial agent, a heat stabilizer, an antioxidant, a release agent, a light stabilizer, a compatibilizer, an inorganic material additive, a surfactant, a coupling agent, a plasticizer, an admixture, a stabilizer, a lubricant, an antistatic agent, a flame proofing agent, a weather-resistance agent, a colorant, an ultraviolet (UV) blocking agent, a filler, a nucleating agent, an adhesion aid, an adhesive, or a combination thereof.

15. A molded product made from the blend composition of a polycarbonate resin and a vinyl-based copolymer according to claim 1.
